(19) United States
(12) Patent Application Publication
(10) Pub. No.: US 2025/0193499 A1
(43) Pub. Date: Jun. 12, 2025

(54) TITLE CREATION SYSTEM, TITLE CREATION METHOD, TITLE CREATION PROGRAM, AND DISTRIBUTOR TERMINAL

(71) Applicant: DWANGO CO., LTD., Tokyo (JP)

(72) Inventors: Kazuki YONEDA, Tokyo (JP); Naoki TAKEDA, Tokyo (JP)

(73) Assignee: DWANGO CO., LTD., Tokyo (JP)

(21) Appl. No.: 18/952,082

(22) Filed: Nov. 19, 2024

(30) Foreign Application Priority Data
Dec. 7, 2023 (JP) 2023-206996

(51) Int. Cl. H04N 21/854; H04N 21/2187; H04N 21/234

(52) U.S. Cl. CPC H04N 21/854; H04N 21/2187; H04N 21/23418

(57) ABSTRACT

A title creation system includes s at least one processor. Before distribution of contents is initiated, the at least one processor acquires distributor information that is information regarding a distributor of the contents, and content information that is information regarding the contents, creates a title of each of the contents by using the distributor information and the content information, and displays the title on a distributor terminal that is a terminal of the distributor.

### FIELD

An aspect of the present disclosure relates to a title creation system, a title creation method, a title creation program, and a distributor terminal.

### BACKGROUND

There is known a technology for automatically creating titles for existing contents. Patent Literature 1 discloses a technology for setting a title for a moving image and the like recorded in a medium. Patent Literature 2 describes a technology for suggesting a title for a product put up for sale in electronic commerce.

### PATENT LITERATURE

[Patent Literature 1] JP2006-109135A
[Patent Literature 2] JP2023-028548A

### SUMMARY

There is a case where a title is set before contents are distributed. In this case, a distributor of the contents needs to set titles for contents to be distributed. It is difficult and time-consuming for the distributor to set an appropriate title. Here, there is a demand for a mechanism that suggests titles of contents while suppressing a distributor's effort.

A title creation system according to an aspect of the present disclosure includes at least one processor. Before distribution of contents is initiated, the at least one processor acquires distributor information that is information regarding a distributor of the contents, and content information that is information regarding the contents, creates a title of each of the contents by using the distributor information and the content information, and displays the title on a distributor terminal that is a terminal of the distributor.

In the aspect, before distribution of contents is initiated, the title of each of the contents is created by using the distributor information and the content information, and the title is displayed on the distributor terminal. According to this, the title of the content can be automatically suggested while suppressing a distributor's effort.

According to the aspect of the present disclosure, it is possible to automatically suggest titles of contents while suppressing a distributor's effort.

### BRIEF DESCRIPTION OF THE DRAWINGS

FIG. 1 is a view illustrating an example of application of a title creation system;

FIG. 2 is a view illustrating an example of a hardware configuration relating to the title creation system;

FIG. 3 is a view an example of a functional configuration relating to the title creation system;

FIG. 4 is a view illustrating an example of a program creation screen;

FIG. 5 is a flowchart illustrating an example of an operation of the title creation system;

FIG. 6 is a view illustrating an example of a functional configuration relating to a title creation system according to a modification example; and

FIG. 7 is a view illustrating an example of a functional configuration relating to a title creation system according to another modification example.

### DETAILED DESCRIPTION

Hereinafter, an embodiment of the present disclosure will be described with reference to the accompanying drawing. In description of the drawings, the same reference numeral will be given to the same or equivalent element, and redundant description will be omitted.

A title creation system according to the present disclosure is a computer system that creates titles of contents to be distributed to a user. The contents represent information that is provided by a computer or a computer system and can be recognized by a person. Electronic data representing contents is referred to as content data. In an example, the contents are moving image contents expressed by a video including a voice. The moving image contents may include a video created by an imaging device such as a camera, may include computer graphics (CG), or may include both the video and the CG. In another example, the contents may be a radio format that is expressed by a voice. The contents can be used for various aspects of information transmission or communication, and can be used in various situations or purposes such as news, education, medical care, games, chat, business transactions, lectures, seminars, training, concerts, surveys, and the like. Content distribution refers to a process executed to provide contents to a user, for example, a process of transmitting information to a user via a communication network.

A title creation system provides contents to a viewer by transmitting content data indicating the contents to a viewer terminal. In one example, the contents are provided from a distributor. The distributor is a person who desires to provide information to a viewer by the title creation system, and is a sender of the contents. The viewer is a person who desires to obtain the information by the title creation system and is a user of the contents. The title creation system transmits the content data provided from the distributor terminal to the viewer terminal. The viewer terminal processes the content data and displays the contents on a screen. The contents are also displayed on a screen of the distributor terminal.

In the present disclosure, an example in which the title creation system is applied to a platform for so-called live distribution will be described. For example, the distributor terminal processes a captured video to create content data, and transmits the content data to a server in real time. A server receives the content data, and transmits the content data to the viewer terminal in real time. This is one aspect of live internet broadcasting. The content data may be created in the title creation system. That is, the title creation system may process a real-time video provided from the distributor terminal to create content data, and transmit the content data to the viewer terminal in real time.

Before starting live distribution, titles of contents are set. Each of the titles is one piece of information that the viewer can obtain before viewing the live distribution. For example, when the viewer accesses the title creation system by using the viewer terminal, a title of each content is displayed on the viewer terminal. The viewer confirms information such as the title and selects the content to view. The title creation system creates a title by using distributor information (first information) that is information regarding the distributor and content information (second information) that is information regarding the content, and proposes the title to the distributor. The distributor information may be information indicating the distributor himself or herself, or may be information indicating a track record associated with past distribution. The distributor information is stored in advance in a predetermined storage device or the like. The content information is information indicating at least a part of the content to be live distributed. The content information can be set via the distributor terminal immediately before the live distribution.

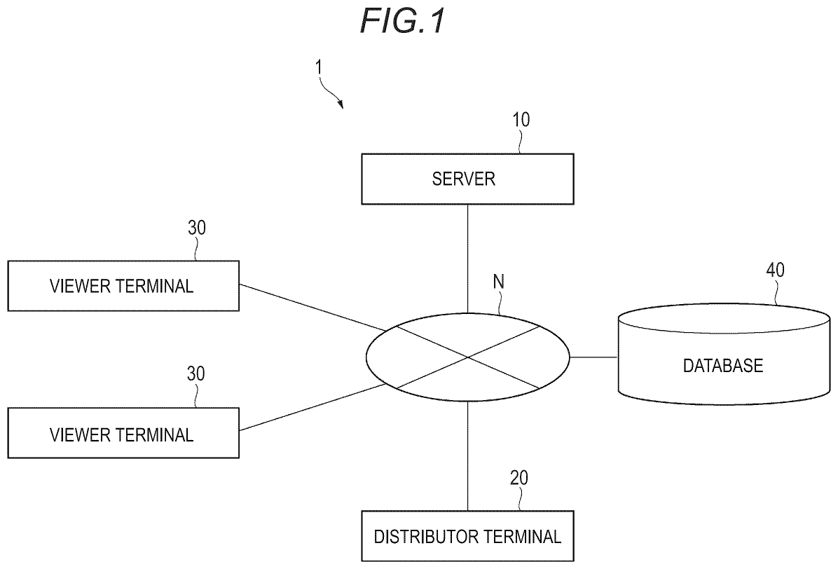

FIG. 1 is a view illustrating an example of application of a title creation system 1. The title creation system 1 includes a server 10. The server 10 is a computer that distributes content data. The server 10 is connected to one or more distributor terminals 20 and one or more viewer terminals 30 via a communication network N. The server 10 is also connected to a database 40 via the communication network N. The communication network N may include the Internet, or may include an intranet.

Each of the distributor terminals 20 is a computer that is used by a distributor. In one example, the distributor terminal 20 has a function of creating contents, and a function of transmitting content data indicating each of the content to the server 10. The distributor terminal 20 may be a personal computer, a high-performance mobile phone (smartphone), a tablet terminal, a wearable terminal (for example, a head-mounted display (HMD), smart glass, and the like), or a mobile phone. The distributor terminal 20 may be an imaging system having a function of imaging, recording, and transmitting a video.

The viewer terminal 30 is a computer used by a viewer. In one example, the viewer terminal 30 has a function of receiving content data from the server 10 and displaying the content data. The viewer terminal 30 may be a personal computer, a high-performance mobile phone, a tablet terminal, a wearable terminal, or a mobile phone.

The distributor operates the distributor terminal 20 to log in to the title creation system 1 and provide contents to a viewer. The viewer operates the viewer terminal 30 to log in to the title creation system 1 and view the contents. In the present disclosure, it is assumed that the viewer and distributor of the title creation system 1 are already logged in. The viewer's login may be omitted. In other words, the title creation system 1 may transmit content data to the viewer terminal 30 of a general viewer who is not logged in. In this case, general viewers who are not logged in can also view the content.

The database 40 is a non-transitory storage device. The database 40 may be constructed as a single database or may be a collection of multiple databases. The database 40 may be a constituent element of the title creation system 1, or may be provided in a computer system separate from the title creation system 1.

The database 40 stores distributor information regarding the distributor. Examples of the distributor information include, but are not limited to, an ID that is an identifier that uniquely identifies the distributor, a distribution history, a nickname, a history of participation in an event, a result of participation in the event, a community size, a degree of attention, and the like. The distribution history is information regarding past distribution. For example, the distribution history is the number of distribution or the number of days since the first distribution. The nickname is a user name that each distributor has set in advance. For example, the distributor performs live distribution by using the nickname. The event is held within a platform that performs live distribution. The event can be participated in by performing the live distribution. The history of participation in the event is information regarding the event that the distributor has participated in in the past. The result of participation in the event is information such as the number of points that the distributor has acquired at the event. The community size is information indicating the size of the community to which the distributor belongs. The community size can be represented, for example, by the number of members (followers), the number of viewers, or the number of comments. The degree of attention is the number of views, the number of comments, and a comment score in past distribution, or the like. The comment score is a numerical value obtained by scoring the emotion indicated by the comment based on, for example, the content or number of characters of the comment.

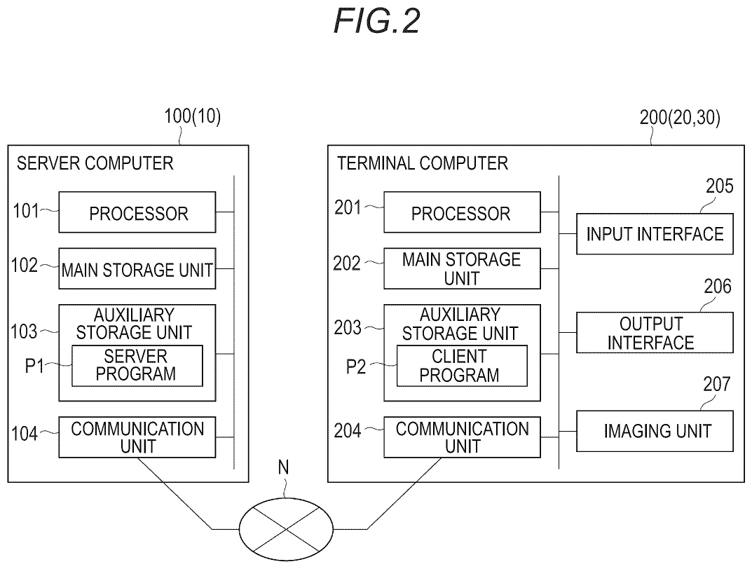

FIG. 2 is a view illustrating an example of a hardware configuration relating to the title creation system 1. In FIG. 2, a server computer 100 functioning as the server 10, and a terminal computer 200 functioning as the distributor terminal 20 or the viewer terminal 30 are illustrated.

As an example, the server computer 100 includes a processor 101, a main storage unit 102, an auxiliary storage unit 103, and a communication unit 104 as hardware constituent elements. The processor 101 is an arithmetic operation device that executes an operating system and an application program, and is, for example, a central processing unit (CPU) or a graphics processing unit (GPU). The main storage unit 102 is a device that stores a program to be executed, an arithmetic operation result, and the like, and is constituted by, for example, a read only memory (ROM) or a random access memory (RAM). Typically, the auxiliary storage unit 103 is a device that can store a larger amount of data as compared with the main storage unit 102, and is constituted by, for example, a non-volatile storage medium such as a hard disk and a flash memory. The auxiliary storage unit 103 stores a server program P1 and various pieces of data for causing the server computer 100 to function as the server 10. The communication unit 104 is a device that executes data communication with other computers via the communication network N, and is constituted by, for example, a network card or a wireless communication module.

In this embodiment, the title creation program is implemented as a server program P1. Respective functional elements of the server 10 are realized by loading the server program P1 onto the processor 101 or the main storage unit 102, and by causing the processor 101 to execute the program. The server program P1 includes codes for realizing the respective functional elements of the server 10. The processor 101 operates the communication unit 104 in accordance with the server program P1 and executes reading and writing of data in the main storage unit 102 or the auxiliary storage unit 103.

The server 10 can be constituted by one or a plurality of computers. In a case of using the plurality of computers, the computers are connected via the communication network N to logically configure a single piece of the server 10.

As an example, the terminal computer 200 includes a processor 201, a main storage unit 202, an auxiliary storage unit 203, a communication unit 204, an input interface 205, an output interface 206, and an imaging unit 207 as hardware constituent elements. The processor 201 is an arithmetic operation device that executes an operating system and an application program, and is, for example, a CPU or a GPU. The main storage unit 202 is a device that stores a program to be executed, an arithmetic operation result, and the like, and is constituted by a ROM or a RAM. Typically, the auxiliary storage unit 203 is a device that can store a larger amount of data as compared with the main storage unit 202, and is constituted by, for example, a non-volatile storage medium such as a hard disk and a flash memory. The auxiliary storage unit 203 stores a client program P2 for causing the terminal computer 200 to function as the distributor terminal 20 or the viewer terminal 3 and various pieces of data. The communication unit 204 is a device that executes data communication with other computers via the communication network N, and is constituted by, for example, a network card or a radio communication module. The input interface 205 is a device that accepts data based on a user's operation or action, and is constituted by, for example, at least one of a keyboard, an operation button, a pointing device, a touch panel, a microphone, a sensor, and a camera. The output interface 206 is a device that outputs data processed by the terminal computer 200, and is constituted by, for example, a display device such as a monitor, a touch panel, and an HMD. The imaging unit 207 is a device that captures an image (video or photo) of the real world, and is, for example, a camera. The imaging unit 207 can also function as the input interface 205.

Respective functional elements of the distributor terminal 20 or the viewer terminal 30 are realized by loading the corresponding client program P2 into the processor 201 or the main storage unit 202 and causing the processor 201 to execute the program. The client program P2 includes codes for realizing the respective functional elements of the distributor terminal 20 or the viewer terminal 30. The processor 201 operates the communication unit 204, the input interface 205, the output interface 206, or the imaging unit 207 in accordance with the client program P2, and performs writing and reading of data in the main storage unit 202 or the auxiliary storage unit 203.

At least one of the server program P1 and the client program P2 may be provided after being non-transitory recorded on a tangible recording medium such as a CD-ROM, a DVD-ROM, and a semiconductor memory. Alternatively, at least one of these programs may be provided as a data signal superimposed on a carrier wave via the communication network N. These programs may be provided separately or in combination.

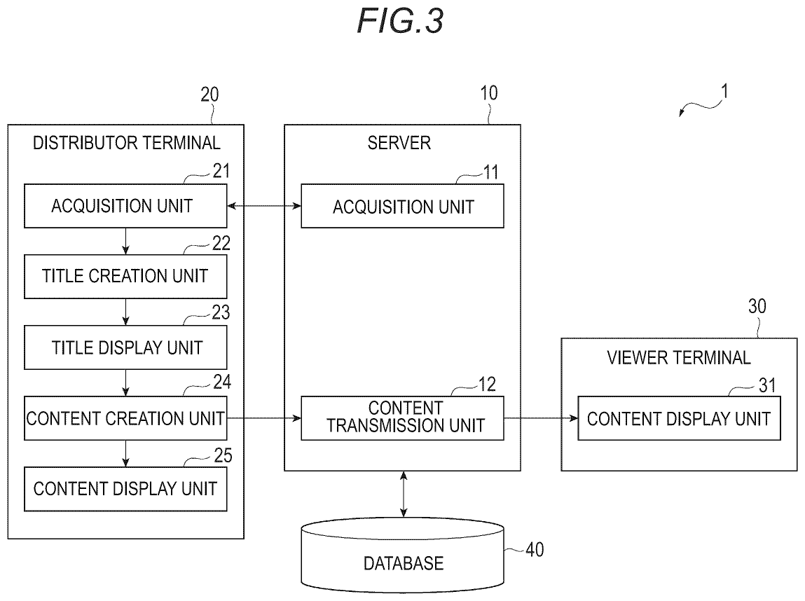

FIG. 3 is a view illustrating an example of a functional configuration relating to the title creation system 1. The server 10 includes an acquisition unit 11 and a content transmission unit 12 as functional elements. The acquisition unit 11 acquires distributor information from the database 40. The content transmission unit 12 receives content data from the distributor terminal 20 and transmits the content data to the viewer terminal 30.

The distributor terminal 20 includes an acquisition unit 21, a title creation unit 22, a title display unit 23, a content creation unit 24, and a content display unit 25 as functional elements. The acquisition unit 21 acquires distributor information and content information. The title creation unit 22 creates a title of a content by using the distributor information and the content information. The title display unit 23 displays the titles on a screen of the distributor terminal 20. The content creation unit 24 creates a content and transmits content data indicating the content to the server 10. The content display unit 25 displays the content on the screen of the distributor terminal 20.

The viewer terminal 30 includes a content display unit 31. The content display unit 31 receives the content data from the server 10, and displays the content on a screen of the viewer terminal 30 on the basis of the content data.

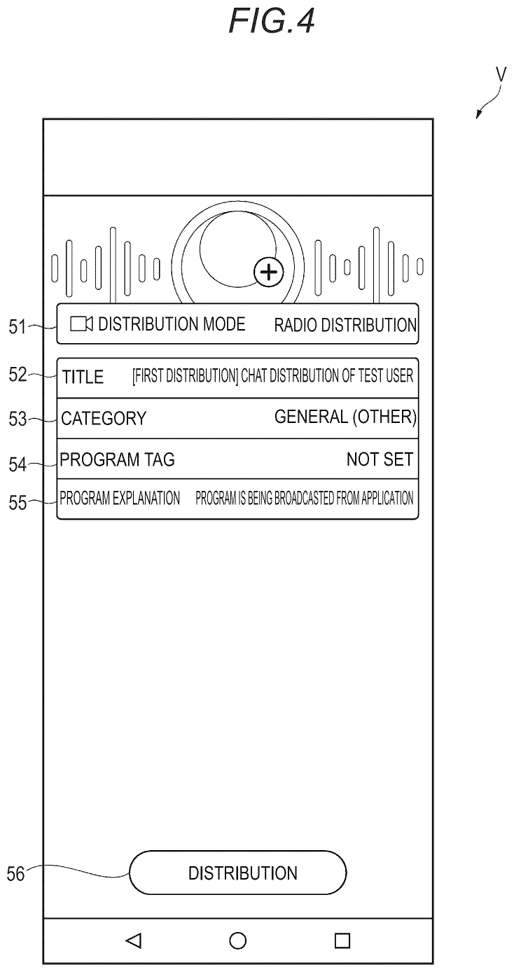

FIG. 4 is a view illustrating an example of a program creation screen V. The program creation screen V is a screen for setting content information and a title before initiating live distribution. The program creation screen V is displayed on the distributor terminal 20. The program creation screen V includes a distribution mode column 51, a title column 52, a category column 53, a program tag column 54, a program description column 55, and a distribution button 56.

The distribution mode column 51 accepts selection of a content distribution mode. The distribution mode is an example of content information. Examples of the distribution mode include, but are not limited to, camera distribution, radio distribution, virtual live distribution, and screen capture distribution. The camera distribution is a format of performing distribution by using a camera. The radio distribution is a format of performing distribution of only an audio. The virtual live distribution is a format of performing distribution by using an avatar. The screen capture distribution is a format of performing distribution by using a screen displayed on the distributor terminal 20. On the program creation screen V, “radio distribution” is set in the distribution mode column 51.

The title column 52 displays a title of a content. The title column 52 displays a title that is automatically created by the title creation system 1. On the program creation screen V, “[first distribution] chat distribution of test user” is displayed in the title column 52.

The title column 52 may accept input of a title of the content. In this case, the title column 52 displays the title that is manually input by a distributor. In another example, the title column 52 may display a keyword that is employed as a title.

The category column 53 accepts selection of a category of the content. The category is an example of content information. Examples of the category include, but are not limited thereto, general (other), games, and cooking. On the program creation screen V, “general (other)” is set in the category column 53.

The program tag column 54 accepts input of a program tag to be assigned to the content. The program tag is an example of content information. The program tag is a keyword related to the content. On the program creation screen V, the program tag column is “not set”.

The program description column 55 accepts input of an explanatory note of the content. The explanatory note is an example of content information. On the program creation screen V, “program is being broadcasted from application” is displayed in the program description column 55.

The distribution button 56 is a button for creating a content and initiating live distribution. The content or the like is created on the distributor terminal 20 in response to pressing of the distribution button 56.

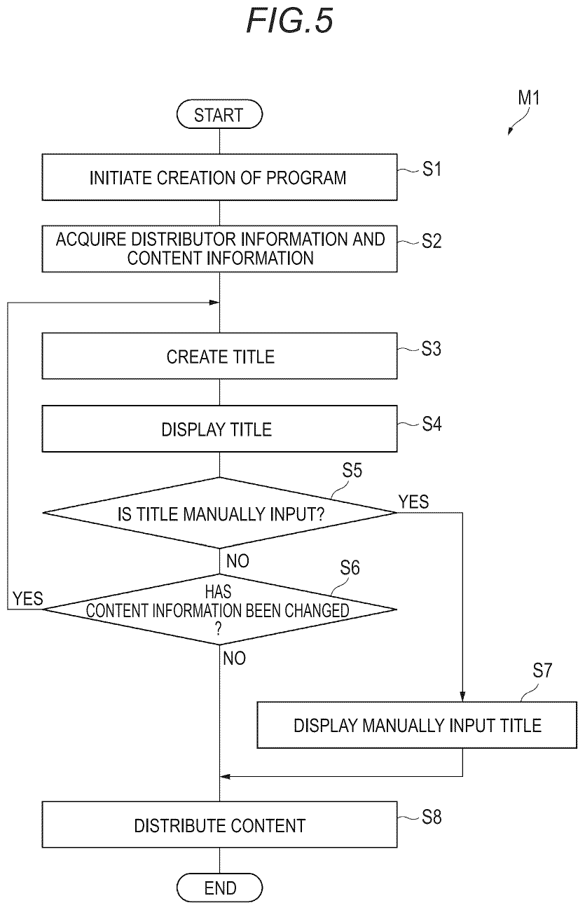

The operation of the title creation system 1 and a title creation method according to an example will be described with reference to FIG. 5. FIG. 5 is a flowchart illustrating an example of the operation of the title creation system 1 as a processing flow M1.

In step S1, the distributor terminal 20 initiates creation of a program for live distribution. The creation of the program represents proceeding to setting of content information.

In step S2, the title creation system 1 acquires distributor information and content information. An acquisition order of the distributor information and the content information is not limited.

The acquisition unit 21 of the distributor terminal 20 makes a request for the server 10 to acquire the distributor information. For example, the acquisition unit 21 may transmit a request including an ID of a distributor to the server 10. The acquisition unit 11 of the server 10 acquires the distributor information from the database 40. For example, the acquisition unit 11 may acquire the distributor information from the database 40 by using the ID of the distributor included in the request. The acquisition unit 11 transmits a response including the distributor information to the distributor terminal 20. The acquisition unit 21 acquires the distributor information by receiving the response including the distributor information from the server 10. In an example, the distributor information may include a distribution history “first distribution” and a nickname “test user”.

The acquisition unit 21 may acquire the content information set by the distributor. In another example, the acquisition unit 21 may acquire content information of initial setting. The content information of initial setting may be set in advance by an operator of the title creation system 1. The content information may include a distribution mode, a category, a program tag, an explanatory note, or the like. In an example, the content information may include a category “general (other)”.

In step S3, the title creation unit 22 of the distributor terminal 20 creates a title of the content by using the distributor information and the content information. For example, the title creation unit 22 creates the title of the content by using a part or the entirety of information included in the distributor information and a part or the entirety of information included in the content information.

The distributor information may include a distribution history of past distribution. The title creation unit 22 may create a title by using a text (first text) corresponding to the distribution history. In an example, the title creation unit 22 may add the first text” [first distribution]” corresponding to the distribution history “first distribution” to the title. In another example, the title creation unit 22 may add the first text “[rookie]” corresponding to the distribution history “within 30 days from first distribution” to the title. In still another example, the title creation unit 22 may leave the first text not set or blank when the distribution history is “passage of 30 days from first distribution”. In this case, the title creation unit 22 may not need to add the first text to the beginning of the title.

The distributor information may include a nickname of the distributor. The title creation unit 22 may create the title by using the nickname. In an example, the title creation unit 22 may add a nickname “test user” to the title.

The content information may include a category of the content. The title creation unit 22 may create the title by using a text (second text) corresponding to the category. In an example, the title creation unit 22 may add the second text “chat” corresponding to a category “general (other)” to the title. In another example, the title creation unit 22 may add the second text “game” corresponding to a category “game” to the title. That is, the second text may be the same character string as the category, or may be a character string different from the category.

The title creation unit 22 may add the first text to the beginning of the title. The title creation unit 22 may add the nickname after the first text to create the title. The title creation unit 22 may add the second text after the nickname. In an example, the title creation unit 22 may create a title “[first distribution] chat distribution of test user”. In this case, the “[first distribution]” is the first text. The “test user” is the nickname. The “test user” is the nickname. The “chat distribution” is the second text. “Of” and “distribution” before and after the second text may be a fixed text string.

In step S4, the title display unit 23 of the distributor terminal 20 displays the title on the screen of the distributor terminal 20. For example, the title display unit 23 may display the title in the title column 52 of the program creation screen V.

In step S5, the title display unit 23 allocates processing depending on whether or not a title has been manually input. For example, the title display unit 23 may determine whether or not a distributor has manually input a title into the title column 52 of the program creation screen V.

In a case where the title has not been manually input (NO in step S5), the process proceeds to step S6. In a case where the title has been manually input (YES in step S5), the process proceeds to step S7.

In step S6, the acquisition unit 21 allocates processing depending on whether or not the content information has been changed. For example, the acquisition unit 21 may determine whether or not the distributor has changed the content information on the program creation screen V. In an example, the acquisition unit 21 may acquire whether or not the distributor has changed the distribution mode column 51, the category column 53, the program tag column 54, or the program description column 55.

In a case where the content information has been changed (YES in step S6), the process returns to step S3. In step S3, in response to the change in the content information, the title creation unit 22 may recreate a title by using the distributor information and the changed content information. In step S4, the title display unit 23 displays the recreated title in the title column 52.

In a case where there is no change in the content information (“NO” in step S6), the process proceeds to step S8.

In step S7, the title display unit 23 displays the manually input title on the screen of the distributor terminal 20. For example, the title display unit 23 displays the manually input title in the title column 52 of the program creation screen V. That is, the manually input title is displayed in the title column 52 instead of the title created by the processing in step S3.

In step S8, the content creation unit 24 of the distributor terminal 20 creates a content. For example, the content creation unit 24 starts creation of the content in response to pressing of the distribution button 56 on the program creation screen V. In an example, the content creation unit 24 may create a content including a video captured by the imaging unit 207. In another example, the content creation unit 24 may create a content based on a content material stored in the auxiliary storage unit 203.

The content creation unit 24 transmits content data indicating the content to the server 10. For example, the content creation unit 24 performs live distribution by continuously distributing the content. In an example, the content creation unit 24 continuously transmits content data indicating the created content to the server 10. The server 10 receives the content data.

The content transmission unit 12 of the server 10 transmits the content data to the viewer terminal 30. For example, when a viewer accesses the title creation system 1 by using the viewer terminal 30, a title of each content is displayed on the viewer terminal 30. The viewer confirms information such as the title and selects a content to view. In response to selection of the content to view, the viewer terminal 30 transmits a content request to the server 10. For example, in response to the content request from the viewer terminal 30, the content transmission unit 12 transmits content data to the viewer terminal 30. The content request is a data signal for making a request for the server 10 to play the content. The viewer terminal 30 receives the content data.

The content display unit 25 of the distributor terminal 20 displays the content created by the content creation unit 24 on a screen. The content display unit 31 of the viewer terminal 30 processes the content data and displays the content on the screen. In a case where the content includes an audio, the content display unit 25 and the content display unit 31 can output the audio included in the content from a speaker.

As described above, the title creation system 1 according to an aspect of the present disclosure includes at least one processor. Before distribution of contents is initiated, the at least one processor acquires distributor information that is information regarding a content distributor, and content information that is information regarding the content, and creates a title of each of the contents by using the distributor information and the content information, and displays the title on a distributor terminal that is a terminal of the distributor.

The title creation method according to another aspect of the present disclosure is executed by the title creation system 1 including at least one processor. The title creation method includes a step of acquiring distributor information that is information regarding a distributor of contents, and content information that is information regarding the content, a step of creating a title of each of the contents by using the distributor information and the content information, and a step of displaying the title on a distributor terminal that is a terminal of the distributor, the steps being initiated before distribution of the content is initiated.

The title creation program according to still another aspect of the present disclosure causes a computer to execute a step of acquiring distributor information that is information regarding a distributor of the contents, and content information that is information regarding the contents, a step of creating a title of each of the contents by using the distributor information and the content information, and a step of displaying the title on a distributor terminal that is a terminal of the distributor, the steps being performed before distribution of the contents is initiated.

According to the present disclosure, before distribution of contents is initiated, the title of each of the contents is created by using the distributor information and the content information, and the title is displayed on the distributor terminal. According to this, it is possible to automatically suggest the title of the content while suppressing a distributor's effort.

The distributor information includes a distribution history of past distribution. At least one processor creates a title by using a text corresponding to the distribution history. In this case, the text corresponding to the distribution history is reflected on the title. In other words, it is possible to reflect the distributor's experience on the title. It is possible to increase the amount of information that viewers of the content can obtain from the title.

The distributor information includes a nickname of the distributor. The at least one processor creates the title by using the nickname. In this case, the nickname of the distributor is reflected on the title. According to this, it is possible to increase the amount of information that viewers of the content can obtain from the title.

The content information includes a category of the content. The at least one processor creates the title by using a text corresponding to the category. In this case, the category of the content is reflected on the title. According to this, it is possible to increase the amount of information that viewers of the content can obtain from the title.

In response to change of the content information, the at least one processor recreates the title by using the distributor information and the changed content information, and displays the recreated title on the distributor terminal. In this case, in response to change of the content information, the changed content information is reflected on the title. In other words, the title is automatically recreated in accordance with change of the content information. According to this, it is possible to automatically suggest the title of the content while suppressing a distributor's effort.

The at least one processor performs live distribution by continuously distributing contents. The live distribution is an example in which a title is set before distribution of the contents. The title creation system 1 of the present disclosure is applicable to a platform that performs live distribution.

The present disclosure is not limited to the above-described embodiments. In implementation of the present disclosure, a shape, an arrangement, and the like of the respective constituent elements can be appropriately changed within a range not departing from the gist of the appended claims.

The distributor information may include at least one among a history of participation in an event, a result of participation in the event, a community size, and a degree of attention. The title creation unit 22 may create a title by using at least one among the history of participation in the event, the result of participation in the event, and the community size. In an example, it is assumed that the distributor has a participation history of participating in a specific event X. In this case, the title creation unit 22 may add a text such as “event X participant” corresponding to the participation history to the title. In another example, it is assumed that the distributor has won the specific event X. In this case, the title creation unit 22 may add a text such as “event X winner” corresponding to the participation result to the title. In still another example, it is assumed that the distributor belongs to a small community. In this case, the title creation unit 22 may add a text such as “welcome, a person who prefers a small community” corresponding to the community size to the title. In still another example, it is assumed that the degree of attention for the distributor is high in the past month. “Degree of attention is high” may refer to whether the degree of attention exceeds a predetermined threshold, or may be within the top n^{th} attention n level among a plurality of distributors. The title creation unit 22 may add a text such as “rapidly rising” corresponding to the degree of attention to the title.

The content information may include at least one among a distribution mode, a program tag, and an explanatory note. The content creation unit 24 may create a title by using at least one among the distribution mode, the program tag, and the explanatory note. In an example, it is assumed that the distribution mode is “camera distribution”. In this case, the title creation unit 22 may add a text such as “face revealed” corresponding to the distribution mode to the title. In another example, it is assumed that the program tag given to the game commentary content is “remake”. In this case, the title creation unit 22 may add a text such as “remake” corresponding to the program tag to the title. In still another example, the title creation unit 22 may add a text corresponding to a part or all of the explanatory note to the title.

The title creation system may be applied to a platform in which a content to be distributed is determined at the time of initiating distribution. For example, the title creation system may be applied to a platform in which a game to be distributed is selected at the time of initiating distribution of a game commentary. In this case, the title creation unit 22 may add a text corresponding to a game selected by the distributor to the title.

The content information may include a thumbnail image. The title creation unit 22 may analyze the thumbnail image by artificial intelligence (AI) or the like, and may create a title by using an analysis result. In an example, the thumbnail image may include an avatar. In this case, the title creation unit 22 may acquire an analysis result indicating that the avatar exists in the thumbnail image. The title creation unit 22 may add a text such as “Vtuber” corresponding to the analysis result.

The title creation unit 22 may create a title by using statistical information regarding a relationship between the title and the number of viewers. For example, the database 40 may store some keywords of the title used in past distribution and the number of viewers in association with each other. In an example, the acquisition units 11 and 21 may acquire a correlation such as a tendency for the number of viewers to increase in a case where a specific keyword is included in the title. That is, the acquisition units 11 and 21 may extract a specific keyword that has a tendency for the number of viewers to increase. The title creation unit 22 may add the specific keyword to the title based on the correlation. The title display unit 23 may display a title including the specific keyword on the screen of the distributor terminal 20. In this case, the specific keyword that has a tendency for the number of viewers to increase is reflected on the title. In another example, the acquisition units 11 and 21 may extract a specific keyword that has a tendency for the number of viewers to decrease. The title display unit 23 may display the specific keyword that has a tendency for the number of viewers to increase or a tendency for the number of viewers to decrease on the screen of the distributor terminal 20. In this case, the keyword used when setting the title is automatically selected. This improves the convenience of the distributor.

The title creation unit 22 may create a title by using a generative AI. The generative AI may output a title by using distributor information, content information, or the like as an input. The title creation unit 22 may use, for example, a general-purpose chatbot constructed based on a large-scaled language model as the generative AI. In an example, the title creation unit 22 may output a title by using distributor information, content information, and an instruction text as an input. The instruction text may be, for example, “based on this information, please generate an appropriate title that can attract more viewers within O characters”, or the like. Training data of the large-scaled language model may be, for example, statistical information or human feedback regarding the association between the number of viewers or the number of comments of past distribution and the title. The large-scaled language model may be a model trained to output a title that tends to increase the number of viewers by performing supervised learning or reinforced learning by using the training data.

The title creation unit 22 may change the title during distribution of the content. For example, the title creation unit 22 may change the title during distribution of the content by analyzing at least a part of a video, an audio, and a comment of the content that has been distributed already. That is, the title creation unit 22 may change the title during distribution based on the content distributed from initiation of the content distribution up to a predetermined point of time. In this case, the title is changed in accordance with the distributed content during distribution of the content. According to this, it is possible to automatically suggest a more appropriate title while suppressing the distributor's effort.

The title creation system may be applied to a platform that performs on-demand distribution. For example, the title creation system may be applied to a platform that performs on-demand distribution of a content that indicates a moving image or an audio. The title creation unit 22 may analyze the uploaded content by AI and create a title by using the analysis result.

The title creation unit 22 may create a plurality of title candidates. The title display unit 23 may display the plurality of title candidates on the screen of the distributor terminal 20. The title display unit 23 may accept a selection of a title candidate by the distributor.

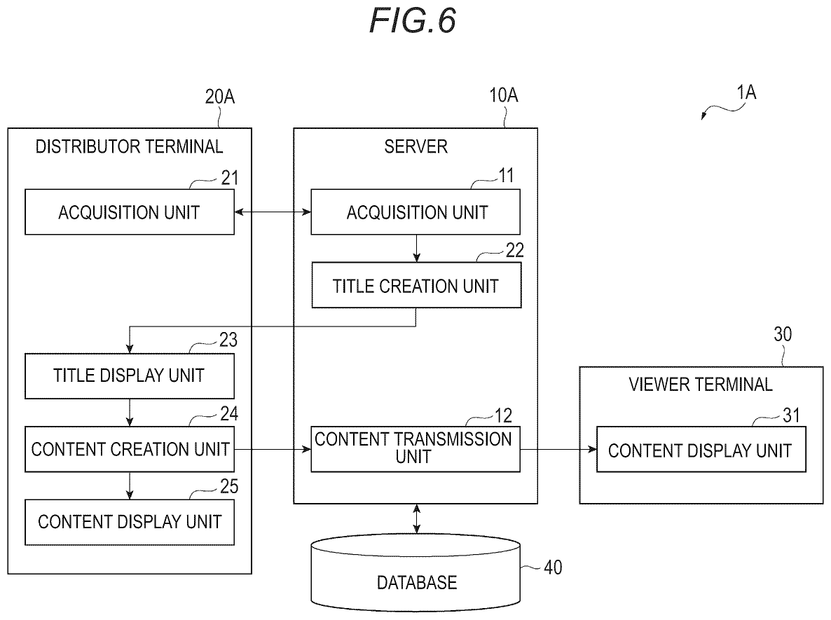

FIG. 6 is a view illustrating an example of a functional configuration relating to a title creation system 1A according to a modified example. The title creation system 1A includes a server 10A, a distributor terminal 20A, the viewer terminal 30, and the database 40. The server 10A is different from the server 10 in that the title creation unit 22 is provided. The distributor terminal 20A is different from the distributor terminal 20 in that the title creation unit 22 is not provided. In other words, the title creation system 1A is different from the title creation system 1 in that a title is created by the server 10A.

In the title creation system 1A, the acquisition unit 21 of the distributor terminal 20A may transmit acquired content information to the server 10A. The acquisition unit 11 of the server 10A may acquire distributor information from the database 40. The title creation unit 22 of the server 10A may create a title by using the distributor information and the content information. The title creation unit 22 may transmit the title to the distributor terminal 20A. The title display unit 23 of the distributor terminal 20A may display the title received from the server 10A on the screen of the distributor terminal 20A.

The distributor terminal 20A according to an aspect of the present disclosure distributes contents to the viewer terminal 30 via the communication network N. The distributor terminal 20A acquires content information before initiation of content distribution. The distributor terminal 20A displays a title created by using the distributor information and the content information.

In the distributor terminal 20A according to an aspect of the present disclosure, before the distribution of the content is initiated, the title of the content is created by using the distributor information and the content information, and the title is displayed on the distributor terminal 20A. According to this, it is possible to automatically suggest the title of the content while suppressing the distributor's effort.

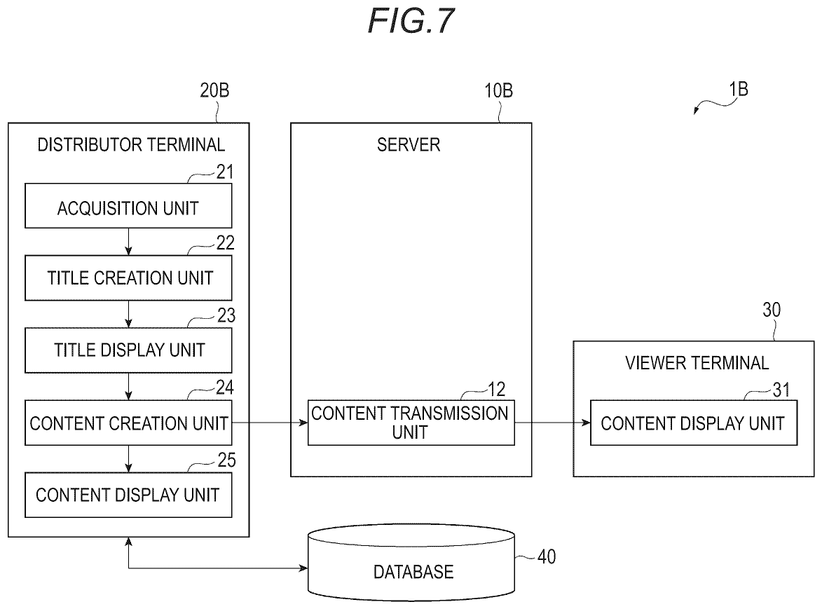

FIG. 7 is a view illustrating an example of a functional configuration relating to a title creation system 1B according to another modification example. The title creation system 1B includes a server 10B, a distributor terminal 20B, the viewer terminal 30, and the database 40. The server 10B is different from the server 10 in that the acquisition unit 11 is not provided. The distributor terminal 20B is different from the distributor terminal 20 in that acquisition of distributor information is not transferred to the server 10B. In other words, the title creation system 1B is different from the title creation system 1 in that the title creation process is completed by the distributor terminal 20B.

In the title creation system 1B, the acquisition unit 21 of the distributor terminal 20B may acquire distributor information from the database 40. The title creation unit 22 of the distributor terminal 20B may create a title by using the distributor information and the content information. The title display unit 23 of the distributor terminal 20B may display the created title on the screen of the distributor terminal 20B.

The distributor terminal 20B according to an aspect of the present disclosure distributes contents to the viewer terminal 30 via the communication network N. Before the distribution of the contents is initiated, the distributor terminal 20B acquires distributor information and content information. The distributor terminal 20B creates a title of each of the content by using the distributor information and the content information. The distributor terminal 20B displays the title.

The title creation system may include a moderator terminal. The moderator terminal is a computer used by a moderator to manage the contents. The system may also include other types of user terminals. The moderator terminal may include functional elements similar to those of the distributor terminal 20, 20A, or 20B.

The title creation system may be constituted by using a server or may be constituted without using the server. That is, the title creation system may be implemented by a client-server system, or may be implemented by P2P (Peer to Peer) or E2E (End to End) encryption, which is a client-client system. In the client-client system, confidentiality of content distribution is improved. The title creation program may be realized as a client program.

In the present disclosure, the expression “at least one processor executes a first process, executes a second process, . . . executes an n^{th} process” or an expression corresponding thereto indicates a concept including a case where an execution subject (that is, the processor) of n processes from the first process to the n^{th} process changes on the way. In other words, this expression indicates a concept including both a case where all n processes are executed by the same processor and a case where the processor changes in the n processes according to any policy.

The processing procedure of the method executed by the at least one processor is not limited to the example in the above-described embodiments. For example, some of the above-described steps may be omitted, or respective steps may be executed in a different order. In addition, any two or more steps among the above-described steps may be combined, or some of the steps may be modified or deleted. Alternatively, other steps may be executed in addition to the above-described steps.

Any parts or all of the functional units described in this specification may be realized by a program. The program stated in this specification may be distributed in a state of being non-temporarily recorded on a computer-readable recording medium, may be distributed via a communication line (including radio communication) such as the Internet, or may be distributed in a state of being installed on any terminal.

On the basis of the above description, a person having an ordinary skill in the art may be able to conceive additional effects and various modifications of the invention, but the aspects of the invention are not limited to the individual embodiments described above. Various additions, modifications, and partial deletions can be made within the scope of the conceptual idea and gist of the invention derived from the contents defined in the appended claims and their equivalents.

For example, a configuration described in this specification as one device (or member, the same shall apply hereinafter) (including a configuration depicted in the drawings as one device) may be realized by a plurality of devices. Conversely, a configuration described in this specification as a plurality of devices (including a configuration depicted in the drawings as a plurality of devices) may be realized by one device. Alternatively, some or all of the means or functions included in a certain device (for example, a server) may be included in another device (for example, a user terminal). Furthermore, a “system” may be constituted by one device, or may be constituted by two or more devices (for example, a server and a user terminal, or a plurality of user terminals).

Furthermore, it is not intended that all of the matters described in this specification are essential. In particular, matters which described are in this specification but are not included in the appended claims can be considered as any additional matters.

It should also be noted that the applicant is only aware of the inventions disclosed in the citation literatures in the “Prior Art Documents” column of this specification, and the present invention does not necessarily aim to solve the problems of the inventions in the citation literatures. The problems to be solved by the invention should be identified by taking into consideration the entire specification. For example, in a case where the specification states that a specific configuration provides a specific effect, it can also be said that the present invention solves a problem that is the reverse of the specific effect. However, it is not necessarily intended that such a specific configuration is an essential requirement.

A summary of the present disclosure is as follows.

[1] A title creation system including:
at least one processor,
wherein before distribution of contents is initiated, the at least one processor
acquires distributor information that is information regarding a distributor of the contents, and content information that is information regarding the contents,
creates a title of each of the contents by using the distributor information and the content information, and
displays the title on a distributor terminal that is a terminal of the distributor.
   [2] The title creation system according to [1],
wherein the distributor information includes a distribution history of past distribution, and
the at least one processor creates the title by using a text corresponding to the distribution history.
   [3] The title creation system according to [1] or [2],
wherein the distributor information includes a nickname of the distributor, and
the at least one processor creates the title by using the nickname.
   [4] The title creation system according to any one of [1] to [3],
wherein the content information includes a category of the content, and
the at least one processor creates the title by using a text corresponding to the category.
   [5] The title creation system according to any one of [1] to [4],
wherein the at least one processor
recreates the title by using the distributor information and the content i information after change in response to the change of the content information, and
displays the recreated title on the distributor terminal.
   [6] The title creation system according to any one of [1] to [5],
wherein the at least one processor analyzes at least a part of a video, a voice, and a comment of the content that has been distributed already during distribution of the content, and changes the title.
   [7] The title creation system according to any one of [1] to [6],
wherein the at least one processor performs live distribution by continuously distributing the contents.
   [8] A title creation method executed by a title creation system provided with at least one processor, the method including:
a step of acquiring distributor information that is information regarding a distributor of the contents, and content information that is information regarding the contents;
a step of creating a title of each of the contents by using the distributor information and the content information; and
a step of displaying the title on a distributor terminal that is a terminal of the distributor, the steps being performed before distribution of the contents is initiated.
   [9] A title creation program causing a computer to execute:
a step of acquiring distributor information that is information regarding a distributor of the contents, and content information that is information regarding the contents;
a step of creating a title of each of the contents by using the distributor information and the content information; and
a step of displaying the title on a distributor terminal that is a terminal of the distributor, the steps being performed before distribution of the contents is initiated.
   [10] A distributor terminal that is provided with at least one processor and distributes contents to a viewer terminal via a communication network,
wherein before distribution of contents is initiated, the at least one processor
   acquires content information that is information regarding the contents, and
   displays titles of the contents which are created by using distributor information that is information regarding a distributor of the contents, and the content information.

### REFERENCE SIGNS LIST

1, 1A, 1B title creation system
10, 10A, 10B server
11 acquisition unit
12 content transmission unit
20, 20A, 20B distributor terminal
21 acquisition unit
22 title creation unit
23 title display unit
24 content creation unit
25 content display unit
30 viewer terminal
31 content display unit
40 database
51 distribution mode column
52 title column
53 category column
54 program tag column
55 program description column
56 distribution button
N communication network
V program creation screen

1. A title creation system comprising:
at least one processor,
wherein before distribution of contents is initiated, the at least one processor
acquires distributor information that is information regarding a distributor of the contents, and content information that is information regarding the contents,
creates a title of each of the contents by using the distributor information and the content information, and
displays the title on a distributor terminal that is a terminal of the distributor.

2. The title creation system according to claim 1,
wherein the distributor information includes a distribution history of past distribution, and
the at least one processor creates the title by using a text corresponding to the distribution history.

3. The title creation system according to claim 1,
wherein the distributor information includes a nickname of the distributor, and
the at least one processor creates the title by using the nickname.

4. The title creation system according to claim 1,
wherein the content information includes a category of the content, and
the at least one processor creates the title by using a text corresponding to the category.

5. The title creation system according to claim 1,
wherein the at least one processor
recreates the title by using the distributor information and the content information after change in response to the change of the content information, and
displays the recreated title on the distributor terminal.

6. The title creation system according to claim 1,
wherein the at least one processor analyzes at least a part of a video, a voice, and a comment of the content that has been distributed already during distribution of the content, and changes the title.

7. The title creation system according to claim 1,
wherein the at least one processor performs live distribution by continuously distributing the contents.

8. A title creation method executed by a title creation system provided with at least one processor, the method comprising:
a step of acquiring distributor information that is information regarding a distributor of the contents, and content information that is information regarding the contents;
a step of creating a title of each of the contents by using the distributor information and the content information; and
a step of displaying the title on a distributor terminal that is a terminal of the distributor, the steps being performed before distribution of the contents is initiated.

9. A title creation program causing a computer to execute:
a step of acquiring distributor information that is information regarding a distributor of the contents, and content information that is information regarding the contents;
a step of creating a title of each of the contents by using the distributor information and the content information; and
a step of displaying the title on a distributor terminal that is a terminal of the distributor, the steps being performed before distribution of the contents is initiated.

10. A distributor terminal that is provided with at least one processor and distributes contents to a viewer terminal via a communication network,
wherein before distribution of contents is initiated, the at least one processor
acquires content information n that is information regarding the contents, and
displays titles of the contents which are created by using distributor information that is information regarding a distributor of the contents, and the content information.
